(19) United States
(12) Patent Application Publication
(10) Pub. No.: US 2017/0272739 A1
(43) Pub. Date: Sep. 21, 2017

(54) AUTOSTEREOSCOPIC DISPLAY DEVICE AND DRIVING METHOD

(71) Applicant: KONINKLIJKE PHILIPS N.V., EINDHOVEN (NL)

(72) Inventors: BART KROON, EINDHOVEN (NL); MARK THOMAS JOHNSON, Eindhoven (NL)

(21) Appl. No.: 15/506,895

(22) PCT Filed: Sep. 25, 2015
(86) PCT No.: PCT/EP2015/072055

§ 371 Date: Feb. 27, 2017

(30) Foreign Application Priority Data
Sep. 30, 2014 (EP) 14187049.3

(51) Int. Cl. H04N 13/04; G02B 26/00; G02B 27/22

(52) U.S. Cl. CPC H04N 13/0497; H04N 13/0447; H04N 13/0404; H04N 13/0413; G02B 27/225; G02B 26/005; H04N 13/0422; H04N 13/0459

(57) ABSTRACT

An autostereoscopic display uses a beam control system and a pixelated spatial light modulator. Different display modes are provided for the displayed image as a whole or for image portions. These different modes provide different relationships between angular view resolution, spatial resolution and temporal resolution. The different modes make use of different amounts of beam spread produced by the beam control system.

### FIELD OF THE INVENTION

This invention relates to an autostereoscopic display device and a driving method for such a display device.

### BACKGROUND OF THE INVENTION

A known autostereoscopic display device comprises a two-dimensional liquid crystal display panel having a row and column array of display pixels (wherein a “pixel” typically comprises a set of “sub-pixels”, and a “sub-pixel” is the smallest individually addressable, single-colour, picture element) acting as an image forming means to produce a display. An array of elongated lenses extending parallel to one another overlies the display pixel array and acts as a view forming means. These are known as “lenticular lenses”. Outputs from the display pixels are projected through these lenticular lenses, which function to modify the directions of the outputs.

The lenticular lenses are provided as a sheet of lens elements, each of which comprises an elongate partially-cylindrical (e.g. semi-cylindrical) lens element. The lenticular lenses extend in the column direction of the display panel, with each lenticular lens overlying a respective group of two or more adjacent columns of display sub-pixels.

Each lenticular lens can be associated with two columns of display sub-pixels to enable a user to observe a single stereoscopic image. Instead, each lenticular lens can be associated with a group of three or more adjacent display sub-pixels in the row direction. Corresponding columns of display sub-pixels in each group are arranged appropriately to provide a vertical slice from a respective two dimensional sub-image. As a user's head is moved from left to right a series of successive, different, stereoscopic views are observed creating, for example, a look-around impression.

FIG. 1 is a schematic perspective view of a known direct view autostereoscopic display device 1. The known device 1 comprises a liquid crystal display panel 3 of the active matrix type that acts as a spatial light modulator to produce the display.

The display panel 3 has an orthogonal array of rows and columns of display sub-pixels 5. For the sake of clarity, only a small number of display sub-pixels 5 are shown in the Figure. In practice, the display panel 3 might comprise about one thousand rows and several thousand columns of display sub-pixels 5. In a black and white display panel a sub-pixel in fact constitutes a full pixel. In a colour display a sub-pixel is one colour component of a full colour pixel. The full colour pixel, according to general terminology comprises all sub-pixels necessary for creating all colours of a smallest image part displayed. Thus, e.g. a full colour pixel may have red (R) green (G) and blue (B) sub-pixels possibly augmented with a white sub-pixel or with one or more other elementary coloured sub-pixels. The structure of the liquid crystal display panel 3 is entirely conventional. In particular, the panel 3 comprises a pair of spaced transparent glass substrates, between which an aligned twisted nematic or other liquid crystal material is provided. The substrates carry patterns of transparent indium tin oxide (ITO) electrodes on their facing surfaces. Polarizing layers are also provided on the outer surfaces of the substrates.

Each display sub-pixel 5 comprises opposing electrodes on the substrates, with the intervening liquid crystal material therebetween. The shape and layout of the display sub-pixels 5 are determined by the shape and layout of the electrodes. The display sub-pixels 5 are regularly spaced from one another by gaps.

Each display sub-pixel 5 is associated with a switching element, such as a thin film transistor (TFT) or thin film diode (TFD). The display pixels are operated to produce the display by providing addressing signals to the switching elements, and suitable addressing schemes will be known to those skilled in the art.

The display panel 3 is illuminated by a light source 7 comprising, in this case, a planar backlight extending over the area of the display pixel array. Light from the light source 7 is directed through the display panel 3, with the individual display sub-pixels 5 being driven to modulate the light and produce the display.

The display device 1 also comprises a lenticular sheet 9, arranged over the display side of the display panel 3, which performs a light directing function and thus a view forming function. The lenticular sheet 9 comprises a row of lenticular elements 11 extending parallel to one another, of which only one is shown with exaggerated dimensions for the sake of clarity.

The lenticular elements 11 are in the form of convex cylindrical lenses each having an elongate axis 12 extending perpendicular to the cylindrical curvature of the element, and each element acts as a light output directing means to provide different images, or views, from the display panel 3 to the eyes of a user positioned in front of the display device 1.

The display device has a controller 13 which controls the backlight and the display panel.

The autostereoscopic display device 1 shown in FIG. 1 is capable of providing several different perspective views in different directions, i.e. it is able to direct the pixel output to different spatial positions within the field of view of the display device. In particular, each lenticular element 11 overlies a small group of display sub-pixels 5 in each row, where, in the current example, a row extends perpendicular to the elongate axis of the lenticular element 11. The lenticular element 11 projects the output of each display sub-pixel 5 of a group in a different direction, so as to form the several different views. As the user's head moves from left to right, his/her eyes will receive different ones of the several views, in turn.

The skilled person will appreciate that a light polarizing means must be used in conjunction with the above described array, since the liquid crystal material is birefringent, with the refractive index switching only applying to light of a particular polarization. The light polarizing means may be provided as part of the display panel or the imaging arrangement of the device.

FIG. 2 shows the principle of operation of a lenticular type imaging arrangement as described above and shows the light source 7, display panel 3 and the lenticular sheet 9. The arrangement provides three views each projected in different directions. Each sub-pixel of the display panel 3 is driven with information for one specific view.

In the designs above, the backlight generates a static output, and all view direction is carried out by the lenticular arrangement, which provides a spatial multiplexing approach. A similar approach is achieved using a parallax barrier.

Another approach is to make use of adaptive optics such as electrowetting prisms and directional backlights. These enable the direction of the light to be changed over time, thus also providing a temporal multiplexing approach. The two techniques can be combined to form what will be described herein as “spatiotemporal” multiplexing.

Electrowetting cells have been the subject of a significant amount of research, for example for use as liquid lenses for compact camera applications.

It has been proposed to use an array of electrowetting prisms to provide beam steering in an autostereoscopic display, for example in the article by Yunhee Kim et al., “Multi-View Three-Dimensional Display System by Using Arrayed Beam Steering Devices”, Society of Information Display (SID) 2014 Digest, p. 907-910, 2014. US 2012/0194563 also discloses the use of electrowetting cells in an autostereoscopic display.

FIG. 3 shows the principle of the electrowetting cell forming a lens. The electrodes in an electrowetting cell include side electrodes and a bottom electrode, and fluids in the electrowetting cell include immiscible oil 20 and water 22. The electrowetting lens is operable by applying different voltages to the side electrodes and the bottom electrode, such that a curvature of the interference of the two incompatible fluids is tuned to modulate the emission directions of light beams traveling through the device. This is shown in the left image. Different voltages applied to the left and right side electrodes and the bottom electrode can also be used to tune an inclined angle of the interface of the incompatible fluids, thereby modulating the emission direction of the light beams traveling through the device. This is shown in the right image. Thus, an electrowetting cell can be used to control a beam output direction and a beam output spread angle.

Because the cell is small it is possible to rapidly switch or steer the shape of the cell. In this way multiple views can be created. The cells can for example form a square grid and it is possible to create an array which enables the light to be steered in one or two directions, similar to lenticular lens arrays (single direction steering) and lens arrays of spherical lenses (two directional steering).

By providing a spatial light modulator (e.g. a transmissive display panel) in alignment with the electrowetting prism array, each cell can correspond to a pixel or sub-pixel (e.g. red, green or blue).

When rendering a 3D image, there are different approaches for generating the desired image quality. Generally, there is a trade off between spatial resolution and angular view resolution. A high angular view resolution means there are different views provided at a relatively large number of angular positions with respect to the display normal, for example enabling a look around effect. This comes at the expense of the spatial resolution. A high spatial resolution means that when looking at a particular view, there are a large number of differently addressed pixels making up that one view. Some display systems also make use of sub-frames. The concept of temporal resolution then also arises, in which a high temporal resolution involves a faster update rate (e.g. providing different images in each sub-frame) than a lower temporal resolution (e.g. providing the same images in each sub-frame).

The terms “spatial resolution”, “angular view resolution” and “temporal resolution” are used in this document with these meanings.

In an autostereoscopic display, the apparent location of the displayed content can for a large part be controlled in the rendering. It is possible for example to let objects come out of the screen towards the viewer as shown in FIG. 4(a) or to choose to let the objects appear behind the panel and have the zero depth content rendered at panel depth as shown in FIG. 4(b).

The invention is based on the insight that it may in some circumstances be desirable to display different image content with different angular resolution. For example, content at zero depth may require a lower angular view resolution whereas content at a non-zero depth may require more angular view resolution to properly render the depth aspect (this comes at the expense of reduced spatial resolution). The invention is further based on the recognition that a different compromise between angular view resolution and the spatial or temporal resolution may be desired for different types of image content either in an image as a whole or in parts of an image.

### SUMMARY OF THE INVENTION

The invention is defined by the claims.

According to an example, there is provided an autostereoscopic display, comprising:

an image generation system comprising a backlight, a beam control system and a pixelated spatial light modulator; and

a controller for controlling the image generation system in dependence on the image to be displayed,

wherein the beam control system is controllable to adjust at least an output beam spread,

wherein the image generation system is for producing a beam-controlled modulated light output which defines an image to be displayed which comprises views for a plurality of different viewing locations,

wherein the controller is adapted to provide at least two display output modes, each of which generates at least two views:

a first display output mode in which a portion or all of the displayed image has a first angular view resolution;

a second display output mode in which a portion or all of the displayed image has a second angular view resolution larger than the first angular view resolution and the associated beam control system produces a smaller output beam spread (52) than in the first display output mode.

This display is able to provide (at least) two autostereoscopic viewing modes. Each mode comprises the display of at least two views to different locations (i.e. neither of the modes is a single view 2D mode of operation). By providing the different display modes, different images or image portions can be displayed differently in order to optimize the way the images are displayed. Higher angular view resolution implies generating more views which will either be at the expense of the resolution of each individual view (the spatial resolution) or at the expense of the frame rate (the temporal resolution). This higher angular view resolution may be suitable for images with a large depth range, where the autostereoscopic effect is more important than the spatial resolution. Similarly, a blurred part of an image may be rendered with lower spatial resolution. An image or image portion with a narrow depth range can be rendered with fewer views, i.e. a lower angular view resolution to give a higher spatial resolution.

The portion of the image to which each mode is applied may be the whole image or else different image portions may have the different modes applied to them at the same time. By “associated” beam control system means the part of the beam control system which processes the light for that portion of the image. It may be a portion of the overall beam control system, or it may the whole beam control system if the beam control system operates on the image as a whole rather than on smaller portions of the image.

The depth content may be rendered mainly behind the display panel. In this way, the depth content that requires the highest angular view resolution seems to be further away from the viewer and requires therefore less spatial resolution.

The beam control system may comprise an array of beam control regions which are arranged in spatial groups, wherein:

when a group is in the first output mode, the beam control regions in the group are each directed to multiple viewing locations at the same time; and

when a group is in the second output mode, the beam control regions in the group are each directed to an individual viewing location.

The spatial groups for example comprise two or more beam control regions which are next to each other. The beam control regions either direct their output to different viewing locations (for high angular view resolution) or they produce a broader output to multiple viewing locations at the same time. In this approach, the spatial resolution in the second mode is smaller than the spatial resolution in the first mode.

In this case, the second output mode may comprise having a first part of the group directed to a first viewing location a second part of the group directed to a second, different viewing location. In the second output mode, views are generated for multiple viewing locations, but at a lower resolution.

In another implementation, in which again the beam control system comprises an array of beam control regions, the controller is adapted to provide sequential frames each of which comprises sequential sub-frames, wherein:

the first mode comprises controlling a beam control region or a group of beam control regions to be in the first output mode for a first and a next sub-frame,

the second mode comprises controlling a beam control region or a group of beam control regions to be in the second output mode directed to a first viewing location for a first sub-frame, then in the second output mode directed to a second, different viewing location for a next sub-frame.

This use of the two modes provides temporal multiplexing. The first mode provides a broad output to (the same) multiple viewing locations in the successive sub-frames, whereas the second mode provides a narrow output to a single viewing location in one sub-frame and a narrow output to a different single viewing location in the next sub-frame. This temporal multiplexing approach can be applied to individual beam control regions, or it can be applied to groups of beam control regions. This approach provides different modes with different relationships between angular view resolution and temporal resolution.

The spatial and temporal multiplexing approaches outlined above can be combined, and various combinations of effects can then be generated. In particular, different combinations of spatial resolution, angular view resolution and temporal resolution can be achieved. A high temporal resolution may be suitable for fast moving images or image portions, and this can be achieved by sacrificing one or both of the angular view resolution and the spatial resolution.

The display may be controlled such that first regions of the displayed image have associated beam control regions or groups of beam control regions in the first output mode and second regions of the displayed image have associated beam control regions or groups of beam control regions in the second output mode, at the same time, and depending on the image content. In this way, an image can be divided into different spatial portions, and the most suitable trade off between the different resolutions (spatial, angular, temporal) can be selected. These spatial portions may for example relate to parts of the image at different depths, e.g. the background and the foreground.

In a most basic conceptual implementation of the examples which make use of groups of beam control regions, each group comprises two regions so that each “part” of a group comprises one region.

However, in order to reduce the processing complexity, the display as a whole can be controlled between the modes. Thus, the display as a whole has the first and second output modes, wherein the second output mode is for displaying a smaller number of views than the first output mode. The beam control system in this case may be a single unit without needing separate or independently controllable regions.

The controller may be adapted to select between the at least two autostereoscopic display output modes based on one or more of:

the depth range of a portion or all of the image to be displayed;

the amount of motion in a portion or all of the image to be displayed;

visual saliency information in respect of a portion of the image to be displayed; or

contrast information relating to a portion or all of the image to be displayed.

These measures may be applied to the displayed image as a whole or to image portions.

In one example, different angular view resolutions are allocated to different portions of an image such that view boundaries (i.e. the junction between one sub-pixel allocated to one view and one sub-pixels allocated to another view) coincide more closely with boundaries between image portions at different depths.

In another example, different angular view resolutions are allocated to different portions of an image such that narrower angular view resolutions are allocated to brighter image portions than to neighboring darker image portions.

The different approaches to the allocation (and sacrifice) of angular view resolution can be combined. They are all based on image content analysis.

In one implementation, the beam control system comprises comprises an array of electrowetting optical cells. However, other beam control approaches are possible which can select between a narrow beam and a broad beam and optionally also provide beam steering. Thus, the beam control system may be for beam steering for example to direct views to different locations, or else the view forming function may be separate. In the latter case, the beam control system can be limited to controlling a beam spread, either at the level of individual image regions or globally for the whole image.

An example in accordance with another aspect of the invention provides a method of controlling an autostereoscopic display which comprises an image generation system comprising a backlight, a beam control system and a pixelated spatial light modulator, wherein the method comprises:

controlling the beam control system to adjust at least an output beam spread,

wherein the method comprises providing two autostereoscopic display output modes, each of which generates at least two views:

a first display output mode in which a portion or all of the displayed image has a first angular view resolution;

a second display output mode in which a portion or all of the displayed image has a second angular view resolution larger than the first angular view resolution and the associated beam control system is controlled to provide a smaller output beam spread than in the first display output mode.

The beam control regions may be arranged in spatial groups, wherein the method comprises:

in the first output mode, directing the beam control regions in the group to multiple viewing locations at the same time; and

in the second output mode, directing the beam control regions in the group to individual viewing locations.

This arrangement enables control of the relationship between spatial resolution and angular view resolution.

In the second output mode, a first part of the group may be directed to a first viewing location a second part of the group may be directed to a second, different viewing location.

This provides different trade offs between angular and spatial resolution.

The method may comprise providing sequential frames, each of which comprises sequential sub-frames, and wherein the method comprises:

in the first mode controlling a beam control region or a group of beam control regions to be in the first output mode for a first and next sub-frame;

in the second mode controlling a beam control region or a group of beam control regions to be in the second output mode directed to a first viewing location for a first sub-frame then in the second output mode directed to a second, different viewing location for a next sub-frame.

This provides different trade offs between angular and temporal resolution. The method may be applied at the level of the full image to be displayed (in which which the beam control system does not need to be segmented into different regions) or at the level of portions of the image.

### BRIEF DESCRIPTION OF THE FIGURES

Embodiments of the invention will now be described, purely by way of example, with reference to the accompanying drawings, in which:

FIG. 1 is a schematic perspective view of a known autostereoscopic display device;

FIG. 2 is a schematic cross sectional view of the display device shown in FIG. 1;

FIG. 3 shows the principle of operation of an electrowetting cell;

FIG. 4 shows how image rendering can be used to change how the autostereoscopic effect is presented;

FIG. 5 shows a display device in accordance with an example of the invention;

FIG. 6 shows a first approach which makes use of control of the beam width, to provide a selectable trade off between spatial resolution and angular view resolution;

FIG. 7 shows control of the beam width with temporal multiplexing of a single beam control region;

FIG. 8 is used to show how temporal, spatial and angular view resolutions can all be controlled;

FIG. 9 shows a disparity map and the ray space;

FIG. 10 shows the use of adjustable beam profiles applied to the ray space of FIG. 9;

FIG. 11 shows a first alternative possible implementation of the required beam control function;

FIG. 12 shows a second alternative possible implementation of the required beam control function; and

FIG. 13 shows a third alternative possible implementation of the required beam control function.

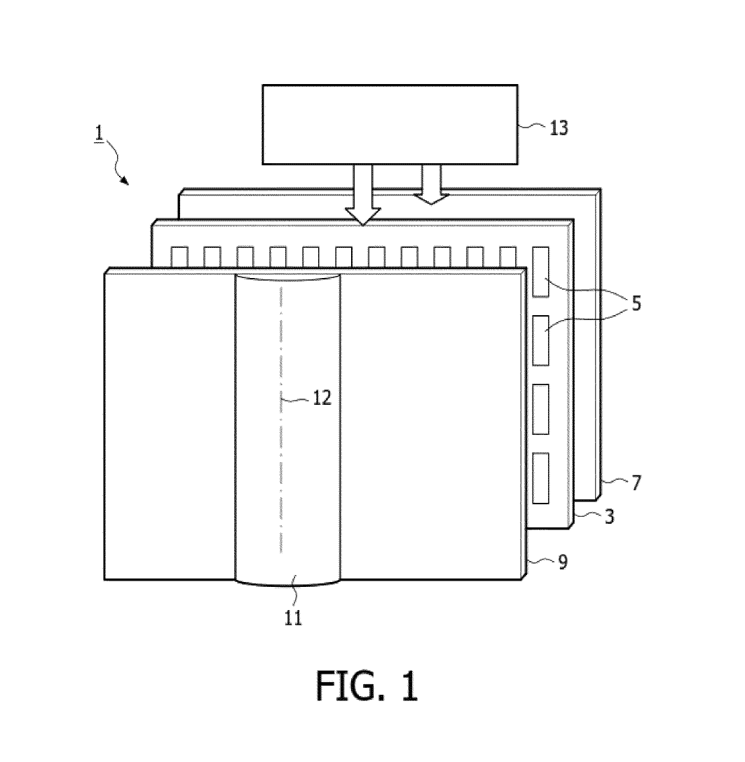

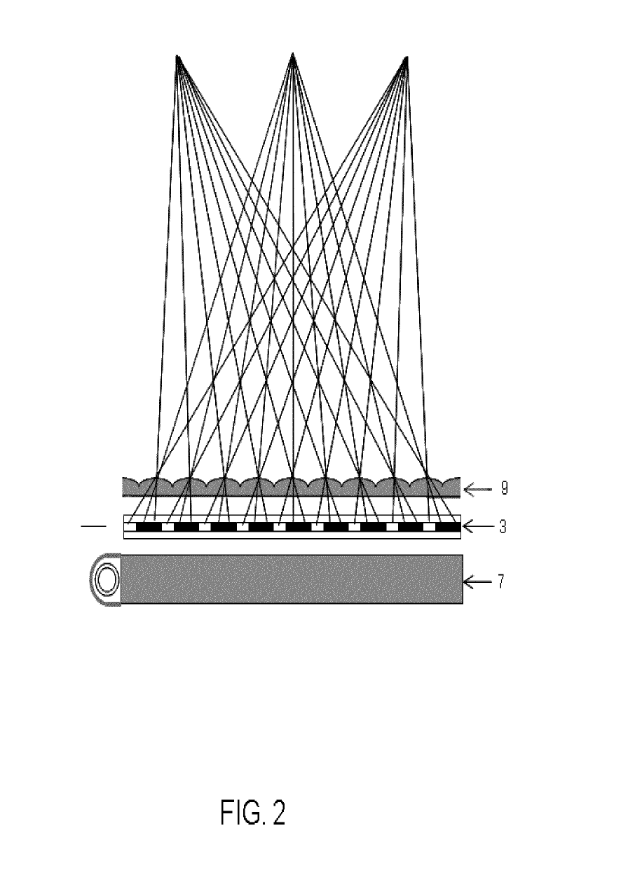

### DETAILED DESCRIPTION OF THE EMBODIMENTS

The invention provides an autostereoscopic display which uses a beam control system and a pixelated spatial light modulator. Different display modes are provided for the displayed image as a whole or for image portions. These different modes provide different relationships between angular view resolution, spatial resolution and temporal resolution. The different modes make use of different amounts of beam spread produced by the beam control system.

FIG. 5 shows a display device in accordance with an example of the invention. FIG. 5(a) shows the device and FIGS. 5(b) and 5(c) illustrate schematically two possible conceptual implementations.

The display comprises 30 a backlight for producing a collimated light output. The backlight should preferably be thin and low cost. Collimated backlights are known for various applications, for example for controlling the direction from which a view can be seen in gaze tracking applications, privacy panels and enhanced brightness panels.

One known design for such a collimated backlight is a light generating component which extracts all of its light in the form of an array of thin light emitting stripes spaced at around the pitch of a lenticular lens that is also part of the backlight. The lenticular lens array collimates the light coming from the array of thin light emitting stripes. Such a backlight can be formed from a series of emissive elements, such as lines of LEDs or OLED stripes.

Edge lit waveguides for backlighting and front-lighting of displays are also known, and these are less expensive and more robust. An edge lit waveguide comprises a slab of material with a top face and a bottom face. Light is coupled in from a light source at one or two edges, and at the top or bottom of the waveguide several out-coupling structures are placed to allow light to escape from the slab of waveguide material In the slab, total internal reflection at the borders keeps the light confined while the light propagates. The edges of the slab are typically used to couple in light and the small out-coupling structures locally couple light out of the waveguide. The out-coupling structures can be designed to produce a collimated output.

An image generation system 32 includes the backlight and further comprises a beam control system 34 and a pixelated spatial light modulator 36. FIG. 5 shows the spatial light modulator after the beam control system but they may be the other way around.

The spatial lighting modulator comprises a transmissive display panel for modulating the light passing through, such as an LCD panel.

A controller 40 controls the image generation system 32 (i.e. the beam control system, the backlight and the spatial light modulator) in dependence on the image to be displayed which is received at input 42 from an image source (not shown). In some implementations, the backlight may also be controlled as part of the beam control function, such as the polarization of the backlight output, or the parts of a segmented backlight which are made to emit. Thus, the beam control function may be allocated differently as between a backlight and a further beam control system. Indeed, the backlight may itself incorporate fully the beam control function, so that the functionality of units 30 and 34 are in one component.

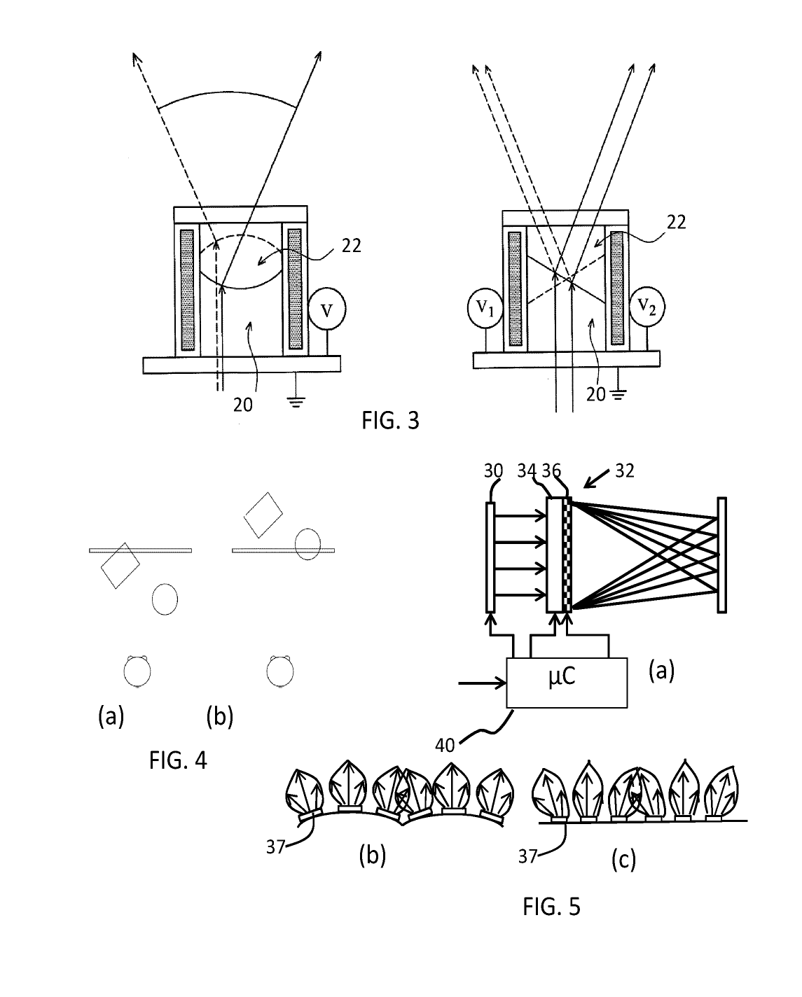

In one example which is based on the use of electrowetting cells, the beam control system comprises a segmented system, having an array of beam control regions, wherein each beam steering region is independently controllable to adjust an output beam spread and optionally also direction. The electrowetting cells may take the form as shown in FIG. 3. In this case, the backlight output can be constant, so that the backlight is only turned on and off. In other examples discussed below, the beam control system may not be segmented and it may operate at the level of the whole display.

The autostereoscopic display has a beam steering function to create views, and additionally in accordance with the invention there is also beam control for controlling a beam spread. The beam steering function needs to direct the light output from different sub-pixels to different view locations. This may be a static function or a dynamic function. For example, in a partially static version, the beam steering function for creating views can be provided by a fixed array of lenses of other beam directing components. In this case, the view forming function is non-controllable, and the electrically controllable function of the beam control system is limited to the beam spread/width.

This partially static version is shown in FIG. 5(b), in which beam controlling regions 37 are provided over a lens surface, so that the beam controlling regions only need to change the beam spread to implement the different modes. The beam spread may be controlled globally so that a segmented system is not needed.

In a dynamic version, the beam direction as well as the beam spread/width can both be controlled electrically. FIG. 5(c) shows an example of segmented beam controlling regions 37 over a planar substrate, with each beam controlling region able to adjust the beam direction (for view forming) and the beam spread angle.

In a segmented beam control system, there may be one sub-pixel of the spatial light modulator associated with each individual beam control region 37 (e.g. electrowetting cell), or else the beam control regions may each cover multiple sub-pixels, for example one full colour pixel, or even a small sub-array of full pixels. Furthermore, the beam control regions 37 may operate on columns of pixels or columns of sub-pixels instead of operating on individual sub-pixels or pixels. This would for example allow steering of the output beam only in the horizontal direction, which is similar conceptually to the operation of a lenticular lens.

The type of beam control approach used will determine if a pixelated structure is used or if a striped structure is used. A pixelated structure will for example be used for an electrowetting beam steering implementation.

The image to be displayed is formed by the combination of the outputs of all of the beam control regions. The image to be displayed may comprise multiple views so that autostereoscopic images can be provided to at least two different viewing locations.

The controller 40 is adapted to provide at least two autostereoscopic display output modes. These modes can be applied to the whole image to be displayed or they can be applied to different image portions.

A first display output mode has a first angular view resolution. A second display output mode has a larger angular view resolution and the associated beam control regions produce a smaller output beam spread to be more focused to a smaller number of views. This approach enables the amount of angular view resolution to be offset against other parameters.

Multiplexing angular information in the light coming from a display panel inherently reduces the resolution along some of the light field dimensions (such as space, time, colour or polarization) to gain angular view resolution. For example, angular view resolution can be traded against spatial resolution or temporal resolution.

With regard to temporal resolution, flicker is visually disturbing so time sequential operation should be limited to keep all sub-frames within maximally 1/50 s=20 ms or preferably less than 1/200 s=5 ms. Blue phase liquid crystal is reported to have a 1 ms switching speed so this gives the possibility for 5 to 20 sub-frames. This is not enough for a high quality single cone autostereoscopic display, at least not without eye tracking so that temporal multiplexing alone is not suitable for autostereoscopic displays producing multiple autostereoscopic viewing directions.

Spatial resolution is very important and should be at least 1080p or even higher to be considered sufficient. However often footage is blurry due to limited depth of field, motion blur and camera lens quality.

Spatiotemporally multiplexed electrowetting displays are able to make good use of available technology and are able to benefit from improvements in spatial resolution and switching speed, for instance as a result of increased frame rates due to oxide TFT developments.

This invention makes use of multiplexing schemes, for example including spatiotemporal multiplexing, which are controlled based on the characteristic of the content and/or viewing conditions. Examples which make clear the potential advantages of control of the multiplexing scheme are:

an object that does not move or only slowly moves can be rendered using less sub-frames.

an object that has a narrow depth range can be rendered using less and broader views.

an object that is blurred can be rendered with less pixels.

Different multiplexing approaches are implemented by enabling control of the beam width based on the image content either locally or globally.

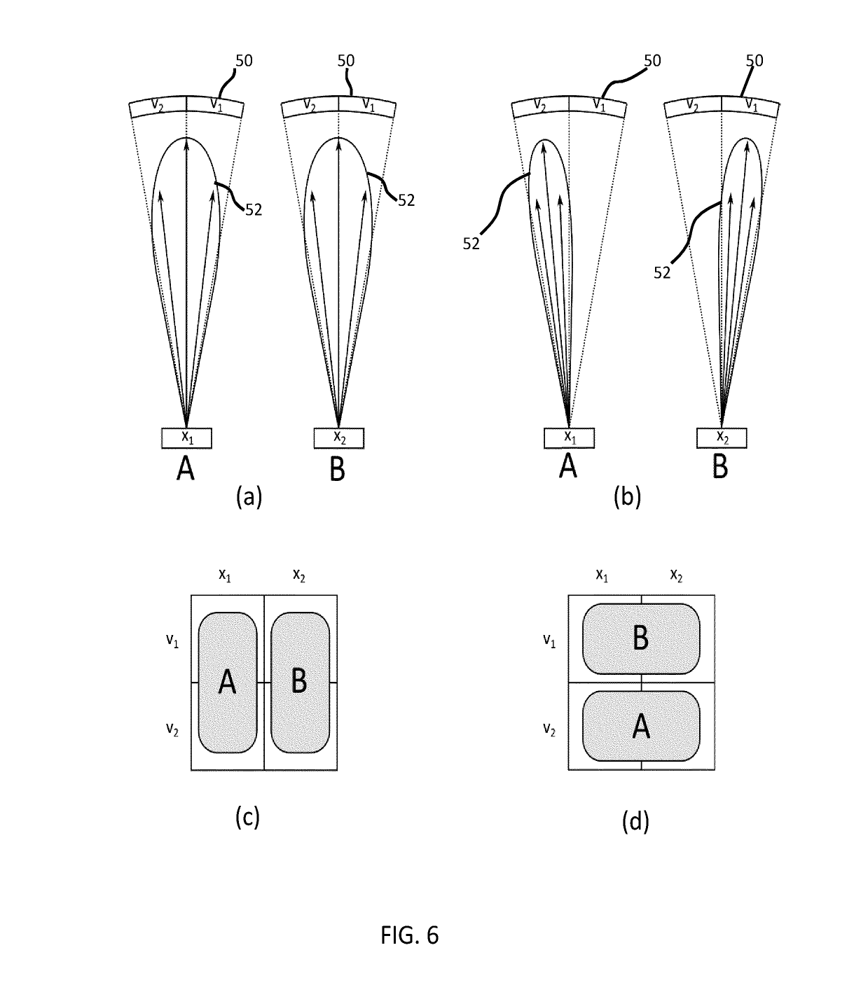

FIG. 6 shows a first approach which makes use of control of the beam width, to provide a selectable trade off between spatial resolution and angular view resolution. For this purpose, the beam control regions are arranged in spatial groups. FIG. 6 shows the most simple grouping, in which each group is a pair of adjacent beam control regions, and a corresponding pair of adjacent sub-pixels x1 and x2. The upper arc 50 indicates the angular view ranges v1 and v2. The envelopes 52 are intensity profiles.

FIG. 6(a) shows a first output mode. The beam control regions in the group are each directed to multiple viewing locations, in particular to views v1 and v2. Thus, image data A is provided to sub-pixel x1 and image data B is provided to sub-pixel x2. Both sub-pixels present their information in both views. This gives a large spatial resolution, since both sub-pixels are visible in each view. In this mode mode the outputs have the same beam shape and direction.

FIG. 6(b) shows a second output mode. The beam control regions in the group are directed to individual and different viewing locations, in particular sub-pixel x1 is directed to v2 and sub-pixel x2 is directed to view v1. Thus, image data A is provided only to view v2 and image data B is provided only to view v1. This gives a large angular view resolution, since views v1 and v2 display different views within the overall displayed image. In this mode, the beams form adjacent views.

Thus, FIG. 6(a) gives more spatial resolution, and FIG. 6(b) gives more angular view resolution. In FIG. 6(a) the intensity profile comprises view ranges v1 and v2 thus having less angular view resolution, however both sub-pixels are visible from both view ranges, thus providing more spatial resolution. In FIG. 6(b) there is more angular view resolution and less spatial resolution by the same argument.

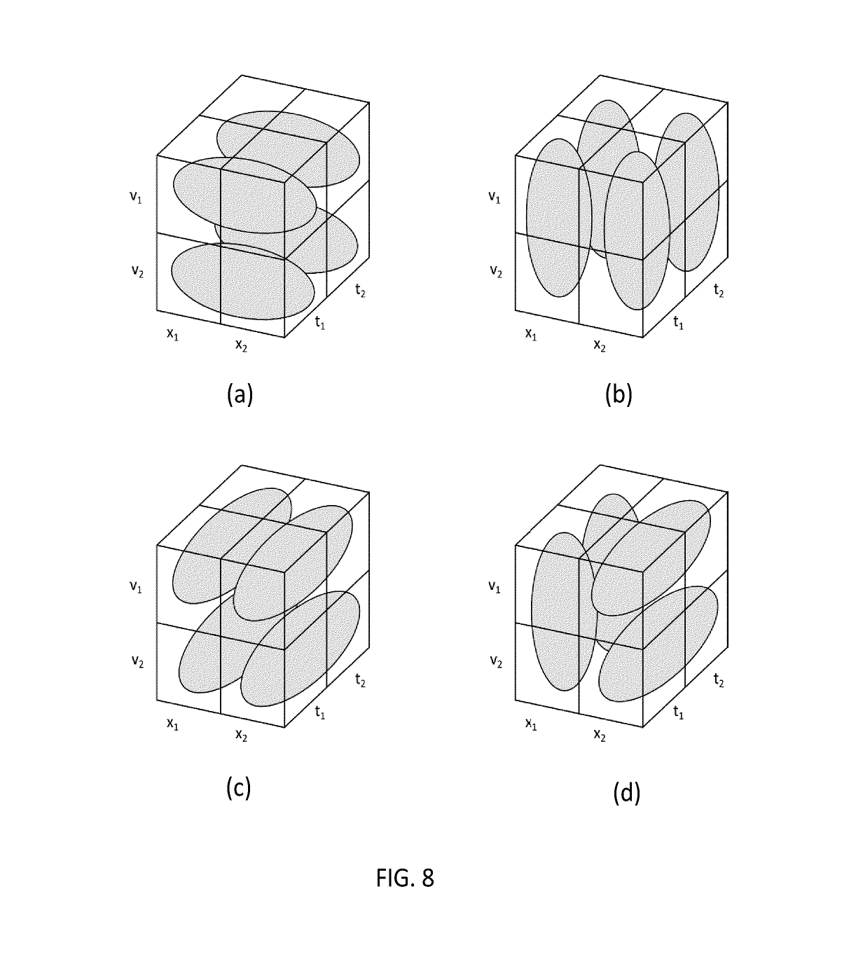

FIG. 6(c) is an abstract representation of the spatial mode of FIG. 6(a) and FIG. 6(d) is an abstract representation of the angular view mode of FIG. 6(b). It shows the views and the pixel locations to which the image data A and B are provided. For example, FIG. 6(c) shows that image data A is provided to both views by sub-pixel x1. FIG. 6(d) shows that image data B is provided only to view v1. Note that the square in FIG. 6(d) is filled (rather than leaving the top left and bottom right blank) for ease of representation in 3D (in FIG. 8). It shows view allocation, namely that each view only has one pixel data spread over the two positions.

The combined profile of the two beams is similar in both modes.

One method to decide which mode to use involves obtaining four luminance or colour values and placing them in a 2×2 matrix. In the high spatial resolution mode of FIG. 6(a), only the average of each column can be represented in each sub-pixel, while in the high angular view resolution mode of FIG. 6(b) only the average of each row as represented in FIG. 6(d) can be represented.

This generally gives two different errors. Because the combined beam profile is similar, the decision as to which mode to use can be made locally based on a simple error metric that—for each mode—measures the colour or luminance difference for both involved views at both involved spatial locations. This gives an error for each mode (ε1 and ε2). The balance for spatial and angular view resolution can then be set by a threshold (λ) that chooses to select for the second mode when λε1>ε2. To always select the mode that gives the lowest error λ=1.

Considering the example of FIG. 6, the input data has values for each position (x) and view (v) combination, such that each combination gives rise to a particular input value:

If we define the input I(xi,vj) as “Iij” in a selected colorspace, then in the first mode corresponding to FIGS. 6(a) and (c):

The colour for A (IA) is the average of I11 and I12.

The colour for B (IB) is the average of I21 and I22.

The error that is made for the first mode is:

ε1=d(I11,IA)+d(I12,IA)+d(I21,IB)+d(I22,IB).

For the second mode, corresponding to FIG. 6(b) and FIG. 6(d):

The colour for A (I′A) is the average of I11 and I21.

The colour for B (I′B) is the average of I12 and I22.

The error that is made for the second mode is:

ε2=d(I11,I′A)+d(I21,I′A)+d(I12,I′B)+d(I22,I′B).

A computation of the average of the colours and the distance between colours depends on the colour space. With RGB and YCbCr it might be a regular per-component averaging operation and a sum-of-absolute-differences operation (SAD) or sum of squared differences operation (SSD) to compute errors. Computation in linear light (RGB without gamma) with regular averaging and L₂ error may also be used (L₂ error is a geometric distance of two vectors, sometimes also known as the “2-norm distance”).

This scheme can be extended to groups of multiple cells that form multiple adjacent views. The number of combinations (modes) will increase rapidly. The above scheme can be generalized to any situation where:

beams of two or more nearby cells are adjacent such that they can be merged to a single broad beam (by applying the same voltages on both cells). This increases the spatial resolution because all cells are now visible from all view points, but lowers the angular view resolution;

beams of two or more nearby cells are overlapping such that they could be split in two or more narrow beams (by applying different voltages to both cells) that together form the original beam shape. This decreases the spatial resolution because only one cell is now visible for each view point, but it increases the angular view resolution.

Instead of having fixed sets of pairs of cells with two modes per pair, this problem can thus also be put in a form that can be optimized by a suitable method such as a semi-global method (e.g. dynamic programming) or a global method (e.g. belief propagation).

The implementation above is based on trading spatial resolution with angular view resolution. An approach which makes use of temporal multiplexing uses multiple sub-frames (e.g. 2 or 3 sub-frames). This gives more error terms and more possibilities.

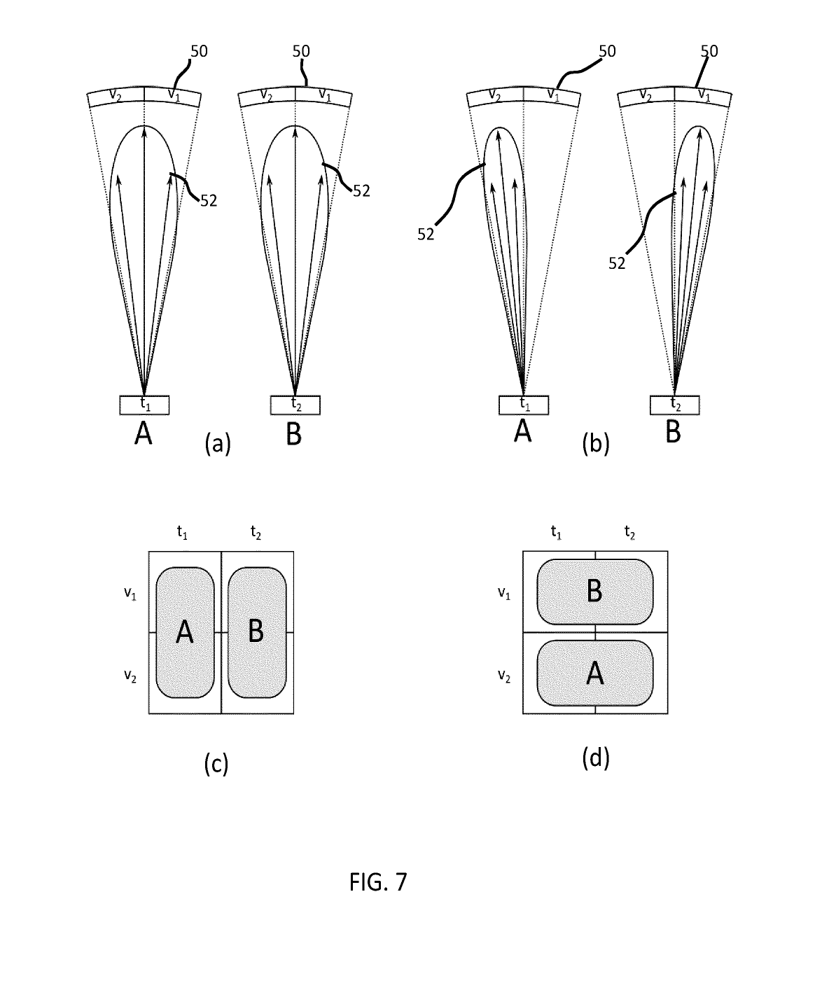

FIG. 7 shows control of the beam width with temporal multiplexing of a single beam control region (e.g. an electrowetting cell). The same references are used as in FIG. 6.

FIG. 7(a) shows a first output mode. The beam control region is directed to multiple viewing locations, in particular to views v1 and v2. Thus, image data A is provided to the sub-pixel in a first sub-frame and image data B is provided to the sub-pixel in a second sub-frame. The sub-pixel presents its information in both views in both sub-frames. This gives a large spatial resolution, since the sub-pixel is visible in each view. In this mode the outputs have the same beam shape and direction.

FIG. 7(b) shows the second output mode. The beam control region is directed to one viewing location v2 with image data A in the first sub-frame, and is directed to viewing location v1 with the image data B in the second sub-frame. This gives a large angular view resolution, since views v1 and v2 display different views within the overall displayed image. In this mode, the beams form adjacent views.

Thus, FIG. 7(a) gives more spatial temporal resolution but less angular view resolution, and FIG. 7(b) gives more angular view resolution but less temporal resolution (since each view is only updated every frame). FIGS. 7(c) and 7(d) are again abstract representations of FIGS. 7(a) and (b).

In the first mode the beam control region cell has the same beam profile in both sub-frames whereas in the second mode the beam control region has adjacent beam profiles in the sub-frames that combine to form the beam profile of the first mode.

FIG. 8 is used to show how temporal, spatial and angular view resolutions can all be controlled. It shows various multiplexing options with a set of two nearby beam control regions cells over two sequential (or at least close in time) sub-frames.

FIG. 8 is essentially a combination of the abstract representations in FIGS. 6 and 7 but as a 3D block.

FIG. 8(a) shows spatial resolution sacrificed for angular and temporal resolution. At any time, different data is provided to the different views, similar to FIG. 6(b).

FIG. 8(b) shows angular view resolution sacrificed for spatial and temporal resolution. At any time, the same data is provided to both views by each sub-pixel, similar to FIG. 6(a).

FIG. 8(c) shows temporal resolution sacrificed for view and spatial resolution. Each sub-pixel provides the same image data for both sub-frames, similar to FIG. 7(d).

FIG. 8(d) shows one possible mixed solution where for the first spatial position, angular view resolution is sacrificed for temporal resolution, while for the other spatial position, the opposite sub-mode is chosen.

The example above requires decision making for each pair of beam control regions, or even for all cells independently but taking other cells into account. Although this local adaption is preferred, there are benefits if the adaption is made on a global (per-frame) level.

One reason to use global adaption is that there may be limited processing power available or part of the rendering chain is implemented in ASIC and cannot be adapted. In one mode more views could be rendered at a lower spatial resolution in comparison to the other mode. The complexity for both modes would be similar.

The choice between global modes can be based on the depth range, amount of motion, a visual saliency map and/or a contrast map.

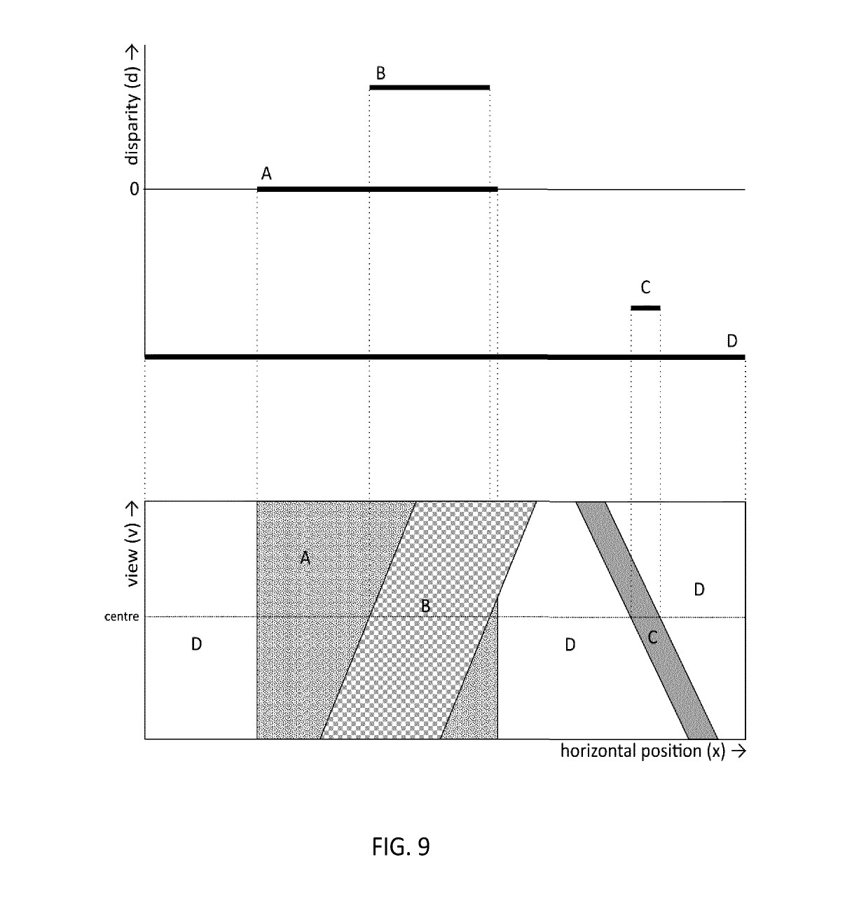

The input data has spatial positions and views. Instead of multiple views, this can be imagined to be a volume of samples in (x,y,v) space where v is for view position. To avoid the use of 3D representations, a common analytical approach is to take a slice that corresponds to a single scan line (y=c.). In FIG. 9, the above image shows the depth map and (x, y) space for a single scan line.

FIG. 9 (top part) shows a depth (otherwise known as disparity) map for a single scan line.

A, B, C and D are planes at constant disparity.

FIG. 9 (bottom part) shows a ray space diagram, which plots the view position against the horizontal position along the selected scan line.

For objects on the screen (zero disparity, e.g. object A), the spatial position is the same for each view, hence the texture of such an object forms vertical lines in the view-direction in ray space, as shown.

For objects away from the screen (non-zero disparity), lines form in another direction. The slope of those lines relates directly to the disparity. Occlusion is also visible in ray space (object B is in front of object A).

Analysis of 3D display images, including the use of ray space diagrams, is presented in the article “Resampling, Antialiasing, and Compression in Multiview 3D displays” of Matthias Zwicker et. al., IEEE Signal Processing Magazine November 2007 pp. 88-96.

The image rendering may be optimized to create sharp depth edges and high dynamic range. This can be achieved by selecting the local beam profiles in dependence on depth jumps. When a light field such as shown in FIG. 9 is regularly quantized, some sub-pixels contribute partially to both sides of a depth jump, creating strong crosstalk.

With adjustable beam profiles, it becomes possible to create a semi-regular sampling by snapping sub-pixels to depth jumps.

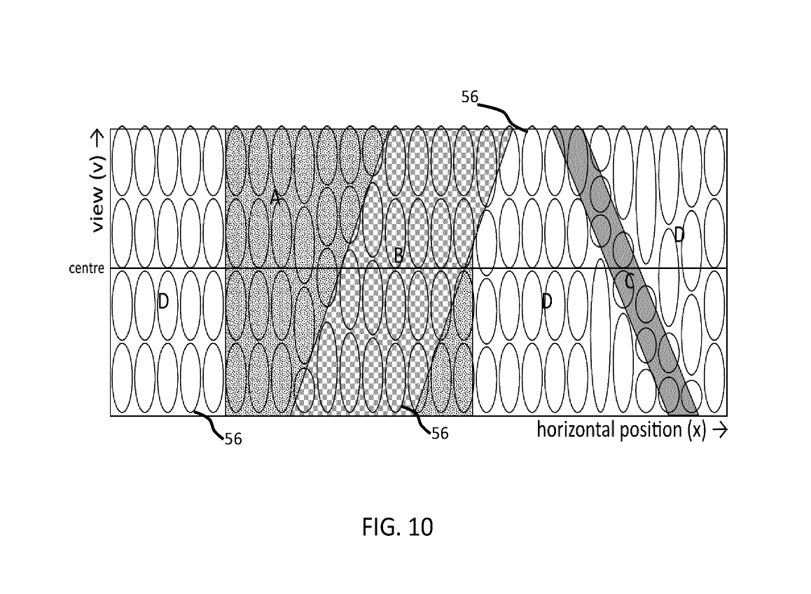

FIG. 10 shows an adaptive sampling approach applied to the image of FIG. 9. In FIG. 10, groups of four pixels form four views. Thus, there are four regions 56 in each column. The height of each region 56 represents the view angle provided by the beam control system in respect of that pixel.

The positions of the views can be determined based on the image data. With regular view sampling such as in the left-most part of FIG. 10, each beam has the same width but different positions.

By optimizing the positions and widths of each of the beams, it becomes possible to have a better image quality (lower total error ε).

There are two examples in FIG. 10:

(i) Depth Jumps (A and B) with Different Texture on Either Side of the Jump.

This creates sharper depth edges, offering more depth effect from the occlusion cue and may reduce the number of beam control regions that are required to render a scene at a given quality. It avoids sub-pixels that span across a depth jump, and which would result in blur.

It can be seen that the different regions 56 again give different angular view resolutions, as represented by their height. The angular view resolutions are selected such that view boundaries coincide more closely with boundaries between image portions at different depths.

### (ii) High Dynamic Range (C and D).

This is based on another effect of changing the beam profile, which is that it also changes the intensity. By having narrower beam profiles in bright regions, it becomes possible to produce a high dynamic range image (objects C and D in FIG. 10). When modeling edges, this effect also has to be taken into account. Consider that object C is a bright but small object (e.g. the sun or a light) and object D is a large but dim object (e.g. the sky or a wall). By choosing narrower beams for C and wider beams for D the available light output (and resolution) is distributed towards the brighter object.

It can again be seen that the different regions 56 again give different angular view resolutions. Different angular view resolutions are allocated in this case to different portions of an image such that narrower angular view resolutions are allocated to brighter image portions than neighboring darker image portions.

The example above makes use of electrowetting cells to provide beam direction and shaping. This enables each sub-pixel (or pixel) to have its own controllable view output direction. However, this approach requires two active matrices of equal resolution giving rise to double the typical cost and power consumption associated with these components.

Furthermore, the electrowetting cells currently have side walls of substantial thickness and height compared to the pitch of the cell. This reduces the aperture and thereby light output and viewing angle. There are alternative solutions for adaptive view forming arrangements:

### 1. LC Barrier

Liquid crystal barriers have a variable aperture width. A narrow aperture results in more view separation, less light output and lower spatial resolution. A broader aperture result in less view separation, more light output and more spatial resolution. LC barriers for example comprise 2D arrays of stripes to realize local adaptation. A single barrier may be used with the barrier formed by stripes or pixels of LC material. The beam width is determined by the number of stripes that are transparent at any time (the slit width). The beam position is determined by which stripes are transparent (the slit position). Both can be controlled. Light output and spatial resolution increases when more stripes are made transparent. View resolution increases when fewer stripes are made transparent.

### 2. Sub-Pixel Area Driving

A display (e.g. AMLCD or AMOLED) can be provided with sub-pixel areas, i.e. each color sub-pixel comprises a set of independently addressable regions, but to which the same image data is applied. The active matrix cell that is associated with the sub-pixel can have an addressing line, a data line and at least one “view width” line. The “view width” line determines how many of the sub-pixel areas are activated. For example, different subsets of these sub-pixel areas may be activated for consecutive sub-frames. The areas are positioned such that they occupy adjacent view positions (e.g. preferably side-by-side instead of top-down). This means they can be used to selectively control the view width, i.e. the beam angle at the output.

### 3. Emitter Stripes

WO 2005/011293 A1 of the current applicant discloses the use of a backlight having light emitting stripes (e.g. OLED).

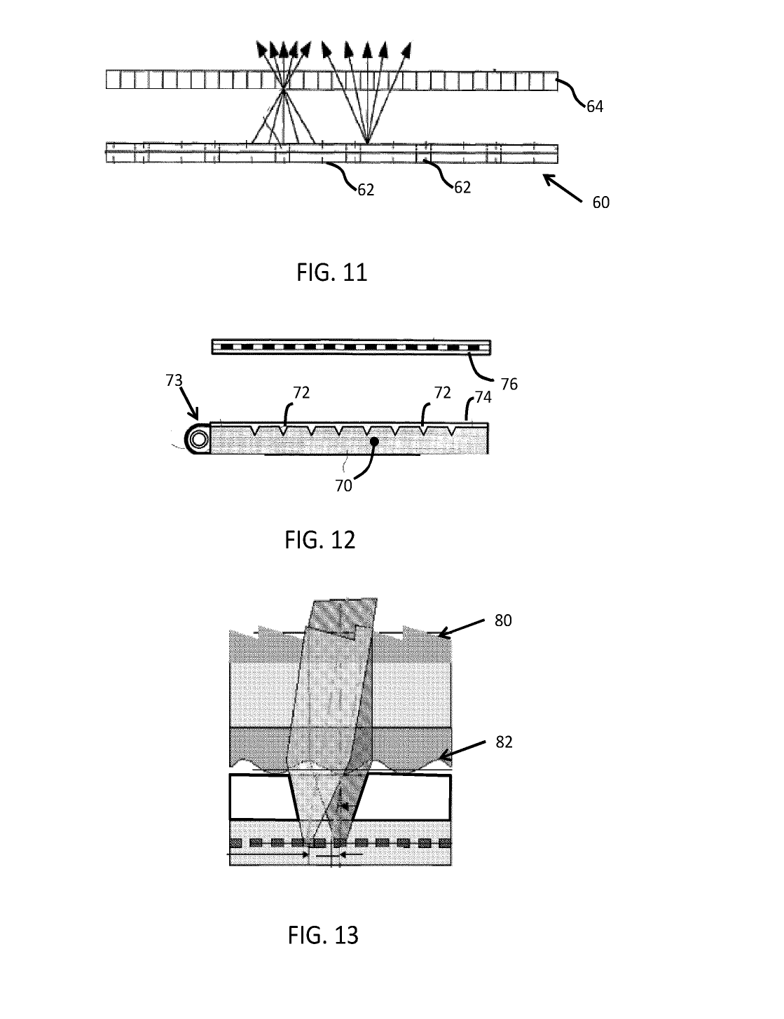

FIG. 11 shows an image from WO 2005/011293. The backlight 60 is an OLED backlight which has electrodes 62 in the form of alternating thick and thin stripes. A conventional display panel 64 is provided over the backlight. The backlight implements switching between 2D and 3D modes.

The backlight stripes are separated by slightly more than the rendering pitch. Instead of single stripes there can be a set of closely packed stripes, where each pack has a pitch slightly larger than the lenticular pitch. By varying the number of stripes or more generally the intensity profile over the stripes within each pack, it becomes possible to change the beam profile of each view.

One potential issue might be that the central stripes are used more often and reach end-of-life earlier. This can be circumvented by regularly or occasionally changing which stripe is central, possibly based on an aging model.

If the backlight that is entirely covered by emitter lines, light steering is possible. This enables left and right stereo views to be projected to the eyes of one or multiple viewers, or allows a head-tracked multi-view system. Time-sequential generation of views and viewing distance adjustment are also possible. This type of backlight can be used to implement the invention.

### 4. Partially Birefringent Waveguide

WO 2005/031412 of the current applicant discloses an autostereoscopic display having a backlight in the form of a waveguide with structures separated by a pitch that is slightly larger than the rendering pitch.

FIG. 12 shows the display. The backlight comprises a waveguide slab 70 which has light out-coupling structures 72 provided on the top face. It is edge lit by a light source 73. The out-coupling structures comprise projections into the waveguide. The top face of the slab of waveguide material is provided with a coating 74 which fills the projections and optionally also provides a layer over the top. The coating has a refractive index higher than the refractive index of the slab of waveguide material so that the light out-coupling structures allow the escape of light.

The light out-coupling structures 72 each comprise a column spanning from the top edge to the bottom edge in order to form stripes of illumination. A display panel 76, in the form of an LCD panel, is provided over the backlight.

The width of the out coupling structures can for example be controlled to achieve the required control of the beam width by using polarized light and birefringence. Each line of out-coupling structures can be formed by a pair of adjacent lines with structures that are constructed from birefringent material. The light source 73 can then be controlled to output polarized light that refracts on either one of the two lines, or unpolarized light that refracts on both.

One implementation of such a light source is to have two sets of light sources with orthogonal polarizers. In one mode there are sets of two sub-frames with alternate polarizations. In the other mode both polarizations are used.

### 5. LC Prisms on Top of Lenticular

WO 2009/044334 of the current applicant disclosed the use of a switchable birefringent prism array on top of a 3D lenticular display to increase the number of views in a time-sequential manner.

FIG. 13 shows the structure used in WO 2009/044334. There is a switchable view deflecting layer 80 in combination with a lenticular lens array 82. The view deflecting layer has different beam steering functions for different incident polarization. This structure can be used, with weakly-diverging birefringent lenses, to implement the beam control required. In one mode the prisms play no role and the display effectively has good view separation. In another mode the prisms partially diverge the light to create less view separation. Local adaptation is possible with an array of electrodes.

### 6. Diffractive Optical Elements (DOEs)

Diffractive optical elements can be incorporated into a waveguide structure to generate autostereoscopic displays. Birefringent DOEs can be used to control beam shapes with polarized light sources. Alternatives might be light sources with different wavelengths (e.g. narrow-band and broad-band red, green and blue emitters), or emitters at different positions.

There are further possible beam control implementations. Multiple switchable lenses or LC graded refractive index lenses may be used, for example of the type as disclosed in WO 2007/072289 of the current applicant. The beam control system may alternatively be based on MEMS devices or electrophoretic prisms.

The controller 40 can be implemented in numerous ways, with software and/or hardware and/or firmware, to perform the various functions required. A processor is one example of a controller which employs one or more microprocessors that may be programmed using software (e.g., microcode) to perform the required functions. A controller may however be implemented with or without employing a processor, and also may be implemented as a combination of dedicated hardware to perform some functions and a processor (e.g., one or more programmed microprocessors and associated circuitry) to perform other functions.

Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media such as volatile and non-volatile computer memory such as RAM, PROM, EPROM, and EEPROM. The storage media may be encoded with one or more programs that, when executed on one or more processors and/or controllers, perform at the required functions. Various storage media may be fixed within a processor or controller or may be transportable, such that the one or more programs stored thereon can be loaded into a processor or controller.

The control method will in practice be implemented by software. Thus, there may be provided a computer program comprises code means adapted to perform the method of the invention when the method is run on a computer. The computer is essentially the display driver. It processes an input image to determine how best to control the image generation system.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. An autostereoscopic display, comprising:
an image generation system, the image generation system comprising:
a backlight;
a beam control system; and
a pixelated spatial light modulator; and
a controller circuit
wherein the controller circuit is arranged to control the image generation system in dependence on the image to be displayed,
wherein the beam control system is arranged to adjust an output beam spread,
wherein the image generation system is arranged to produce a beam-controlled modulated light output,
wherein the beam-controlled modulated output defines an image to be displayed, the image comprising views for a plurality of different viewing locations,
wherein the controller is arranged to provide at least two display output modes, each of which generates at least two views:
a first display output mode in which a portion or all of the displayed image has a first angular view resolution;
a second display output mode in which a portion or all of the displayed image has a second angular view resolution larger than the first angular view resolution and the beam control system produces a smaller output beam spread than in the first display output mode.

2. The display as claimed in claim 1,
wherein the beam control system comprises an array of beam control regions arranged in spatial groups,
wherein when a group is in the first output mode, the beam control regions in the group are each directed to multiple viewing locations at the same time;
wherein when a group is in the second output mode, the beam control regions in the group are each directed to an individual viewing location.

3. The display as claimed in claim 2, wherein when a group is in the second output mode, a first part of the group directed to a first viewing location, and a second part of the group directed to a second, different viewing location.

4. The display as claimed in claim 2,
wherein the controller is arranged to provide sequential frames, each of which comprises sequential sub-frames,
wherein the first mode comprises controlling at least one beam control region to be in the first output mode for a first and a next sub-frame and directed to the same multiple viewing locations in the first and next sub-frames;
wherein the second mode comprises controlling at least one beam control region to be in the second output mode directed to a first viewing location for a first sub-frame and then in the second output mode directed to a second, different viewing location for a next sub-frame.

5. The display as claimed in claim 1,
wherein the beam control system comprises an array of beam control regions,
wherein first regions of the displayed image have at least one beam control region in the first output mode and second regions of the displayed image have at least one beam control region in the second output mode, at the same time, and depending on the image content.

6. The display as claimed in claim 2, wherein each group comprises two regions.

7. The display as claimed in claim 1,
wherein the first output mode is applied to the whole displayed image or the second output mode is applied to the whole displayed image,
wherein the second output mode is for displaying a smaller number of views than the first output mode.

8. The display as claimed in claim 1, wherein the controller is arranged to select between the at least two autostereoscopic display output modes based on one or more of:
the depth range of a portion or all of the image to be displayed;
the amount of motion in a portion or all of the image to be displayed;
visual saliency information in respect of a portion of the image to be displayed;
contrast information relating to a portion or all of the image to be displayed.

9. The display as claimed in claim 1, wherein the beam control system comprises an array of electrowetting optical cells.

10. A method of controlling an autostereoscopic display, the autostereoscopic display comprising an image generation system, the image generation system comprising a backlight, a beam control system and a pixelated spatial light modulator, the method comprising:
controlling the beam control system to adjust at least an output beam spread,
providing two autostereoscopic display output modes, each of which generates at least two views:
a first display output mode in which a portion or all of the displayed image has a first angular view resolution;
a second display output mode in which a portion or all of the displayed image has a second angular view resolution larger than the first angular view resolution and the beam control system is controlled to provide a smaller output beam spread than in the first display output mode.

11. The method as claimed in claim 10 wherein the beam control system comprises an array of beam control regions arranged in spatial groups, further comprising:
in the first output mode, directing the beam control regions in the group to multiple viewing locations at the same time; and
in the second output mode, directing each beam control region in the group to an individual viewing location.

12. The method as claimed in claim 11, further comprising in the second output mode controlling all beam control regions in the group to be in the second output mode, wherein a first part of the group is directed to a first viewing location and a second part of the group directed to a second, different viewing location.

13. The method as claimed in claim 11, further comprising:
providing sequential frames each of which comprises sequential sub-frames,
in the first mode controlling at least one beam control region to be in the first output mode for a first and next sub-frame image and directed to the same multiple viewing locations in the first and next sub-frames;
in the second mode controlling at least one beam control region to be in the second output mode directed to a first viewing location for a first sub-frame then in the second output mode directed to a second, different viewing location for a next sub-frame.

14. The method as claimed in claim 10, wherein the beam control system comprises an array of beam control regions, further comprising:
providing first regions of the displayed image with beam control regions or groups of beam control regions in the first output mode;
providing second regions of the displayed image with beam control regions or groups of beam control regions in the second output mode, at the same time; and depending on the image content.

15. The method as claimed in claim 10, wherein the controller is arranged to select between the at least two autostereoscopic display output modes based on one or more of:
the depth range of a portion or all of the image to be displayed;
the amount of motion in a portion or all of the image to be displayed;
visual saliency information in respect of a portion of the image to be displayed; or
contrast information relating to a portion or all of the image to be displayed.

16. The method as claimed in claim 10, wherein the beam control system comprises an array of beam control regions, further comprising:
providing first regions of the displayed image with beam control regions or groups of beam control regions in the first output mode; and
applying the first output mode or the second output mode to the whole displayed image, wherein the second output mode comprises displaying a smaller number of views than the first output mode
